(19) United States
(12) Patent Application Publication
(10) Pub. No.: US 2014/0172514 A1
(43) Pub. Date: Jun. 19, 2014

(54) METHOD AND APPARATUS FOR CALCULATING PERFORMANCE INDICATORS

(71) Applicant: LEVEL 3 COMMUNICATIONS, INC., Broomfield, CO (US)

(72) Inventors: Kirt Richard Schumann, Westminster, CO (US); Matthew Robert Weir, Broomfield, CO (US)

(73) Assignee: LEVEL 3 COMMUNICATIONS, INC., Broomfield, CO (US)

(21) Appl. No.: 13/715,708

(22) Filed: Dec. 14, 2012

(51) Int. Cl. G06Q 10/06

(52) U.S. Cl. CPC G06Q 10/06393
USPC 705/7.39

(57) ABSTRACT

A method and apparatus for generating performance indicators and improving performance based on metrics is disclosed. During work on a user story (project) for completion, teams and individuals perform work. This work on the user story is tracked and based on the tracking of the work, the system generates or receives metrics that define the team and individual actions. These metrics are used to calculate performance indicators which are provided to a manager, the team, or an individual. The calculation may include use of a weighting value and comparison of the performance indicator to a threshold. Responsive to the performance indicators various actions may occur including: providing training, moving an individual from the team to a different team, changing one or more physical processes by which work on a user story occurs, and terminating employment of an individual on a team.

### 1. FIELD OF THE INVENTION

The innovation relates generally to performance analysis and in particular to a method and apparatus for evaluating and ranking team and individual performance.

### 2. RELATED ART

Companies and government agencies may employ hundreds or thousands of employees within a single department and within each department the employees may be assigned to one of numerous different teams and also assigned to work on a number of different projects, each of which may have different tasks. The projects may take weeks to years to complete and involve thousands of man-hours and hundreds of thousands of dollars. Due to the overwhelming size of such projects and the number of workers involved, the task of tracking the project's progress based on the work of each team and individual is overwhelming to upper management or team managers.

To address this need in the art, numerous helpful software tools have been developed to track the project's progress. These software tools are available from various companies including Agile Software Corp located in San Jose, Calif. and Rally Software located in Boulder, Colo. The software tools provide means for managers to track the employee's work on a project using known metrics such as the number of projects completed within a particular time frame, number of defects in the project, and productivity.

One common format for tracking a project's progress is based on Agile software development methods. Agile software development may best be described as a group of software development methods based on iterative and incremental development, where requirements and solutions evolve through collaboration between customers and programmers.

During development of the software, the progress and actions of the employees working on the software, such as computer programming, may be tracked and recorded. The data that represents the progress and actions of the employees is input into the software by individual employees or managers. The software tools process the data and generate numeric values, referred to as metrics that define the progress of the project. These known metrics include but are not limited to productivity, quality, efficiency, and predictability.

While these parameters or metrics are helpful to track the project, this raw data provides little useful information for a team manager or higher level management to evaluate and rate performance of a team or individual against other teams or individuals, or against standardized performance levels. Managers are only provided a metric, which is just a numeric value that represents project productivity, quality, efficiency, and predictability. But these numeric values do not provide strong indicators of a team's performance or an individual performance or how those performances relate to objective standards. Hence, it is difficult for managers to evaluate these raw numbers and assign an importance to metric value. Likewise, making management decisions based on raw metrics is difficult.

Therefore, there exists a need in the art for an improved method and system for processing and evaluating this team and individual data into meaningful comparisons which are the basis for evaluations, team and individual feedback, training opportunities, and team assignments.

### SUMMARY

To overcome the drawbacks of the prior art and provide additional benefits, a method for determining performance indicators and improving performance based on the performance indicators is disclosed. This method includes receiving a user story for completion such as from a customer or an entity within the company. The user story may define a request for a computer programming project for a customer. The user story is assigned to one or more teams and the teams are made up of individuals. To complete the user story, the team and individuals perform computer programming on a user story to write software code. One or more aspects of the computer programming of the user story by the team and individuals are tracked. Then, this exemplary method operation generates two or more metrics, based on the tracking, regarding the team and individual actions when writing software code for the user story.

The method calculates one or more performance indicators using two or more metrics and displays the one or more performance indicators, such as on a computer screen, or send the indicators in a message. Responsive to the one or more performance indicators, one or more actions may be taken. These actions may include but are not limited to providing training to a team or an individual on the team, moving an individual from the team to a different team, changing one or more physical processes by which the team or an individual on a team works on the user story, or terminating employment of an individual on a team.

In one embodiment calculating a performance indicator includes calculating a team performance indicator using the following equation:

$$Team Performance = \frac{\begin{matrix}Throughput Average - \\ ( Weighting Value * Defect Trend )\end{matrix}}{( Cycle Time Average ) + Predictability}$$

In one embodiment calculating a performance indicator includes calculating an individual performance indicator using the following equation:

$$Individ . Perfor . - \frac{\begin{matrix}Throughput Average - \\ ( Weighing Value * Defect Trend )\end{matrix}}{\begin{matrix}( ( Cycle Time Aver . \vert Cycle Time Stand . Deviat . ) * \\ \frac{Individ . Throughput Aver .}{Team Throughtput Average} \end{matrix}}$$

The metrics may comprise any of the following metrics: Team Productivity Metric, IC Productivity Metric, Throughput Average, Quality Metric, Defect Trend, Efficiency Metric, Cycle Time Average, Predictability Metric, and Cycle Time Standard Deviation. In one variation the steps of generating two or more metrics and calculating one or more performance indicators are performed by machine readable code that is stored in a memory and executed by a processor of a computing device. This method of operation may further include establishing a weighting value and applying the weighting value to one or more metrics when calculating the one or more performance indicators. Likewise, this method may further include establishing a performance indicator threshold and comparing the performance indicator threshold to one or more performance indicators to generate a non-numeric indicator of the calculated performance indicator.

Also disclosed is a method of calculating performance indicators that includes receiving or generating two or more metrics regarding team performance or individual performance on a project and calculating one or more performance indicators using two or more metrics such that the performance indicators indicate the performance of a team or an individual. This method of operation then displays the one or more performance indicators on a screen to be viewed by a person, such as a manager.

In one embodiment this method further includes taking one or more actions responsive to or based on the one or more performance indicators, such as but not limited to providing training to a team or an individual on the team, moving an individual from the team to a different team, changing one or more physical processes by which the team or an individual on a team performs work on the user story, or terminating employment of an individual on a team.

It is contemplated that the metrics may be one or more of the following metrics: Team Productivity Metric, IC Productivity Metric, Throughput Average, Quality Metric, Defect Trend, Efficiency Metric, Cycle Time Average, Predictability Metric, and Cycle Time Standard Deviation. This method may also include establishing a weighting value and applying the weighting value to one or more metrics when calculating the one or more performance indicators. In one variation, the method further includes establishing a performance indictor threshold and comparing the performance indictor threshold to one or more performance indicators to generate a non-numeric indicator of the calculated performance indicator.

To execute the method disclosed herein a system for calculating a performance indicator is also disclosed. In one embodiment this system includes a processor configured to execute machine readable code. The processor accesses the machine readable code in a memory. The memory stores the non-transitory machine readable code that is configured to receive input regarding team activity, individual activity, or both on a project. Based on the activity, the machine readable code generates metrics defining the team activity, individual activity, or both on the project. Then, it calculates a team performance indicator, an individual performance indicator, or both based on at least two of the metrics. After calculation, the indicators may be output from the system, presented on the system, such as on a screen, or sent to a user of the system.

In one embodiment the machine readable code is further configured to establish a weighting value and apply the weighting value to one or more metrics when calculating the team performance indicator, individual performance indicator, or both. It is also contemplated that the machine readable code may be configured to receive a performance indicator threshold and compare the performance indicator threshold to team performance indicator or the individual performance indicator. Responsive to the comparison, a grade or other indicator of performance is output from the system.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram of an example environment of operation and overview of components.

FIG. 2 is an example block diagram of a computer system or computing device configured to operate as described herein.

FIG. 3 illustrates an operational flow diagram of an example method of operation.

FIG. 4 illustrates exemplary combined or summarized data results in the form of development metrics for an exemplary group.

FIG. 5 illustrates an expanded set of development metrics for development groups.

FIG. 6 illustrates an exemplary key for the development metrics for team performance indicators ratings as shown in FIG. 5.

FIG. 7 illustrates a chart of development metrics for individual team members of Agile Team.

FIG. 8 illustrates an exemplary key for the individual contributor performance indicators ratings as shown in FIG. 7.

FIG. 9 illustrates an exemplary chart of definitions with team and team member goals for domain metrics, scrum team metrics, and individual contributor metrics.

### DETAILED DESCRIPTION

To overcome the drawbacks of the prior art and provide additional benefits, disclosed herein is a method and apparatus for receiving and processing project data and metrics to generate performance indicators which may be used to evaluate team performance and individual performance. Based on the performance indicators, which reveal the team performance and individual performance, any number of different management decisions may be made to improve or adjust the performance indicators and eventually improve team and individual performance.

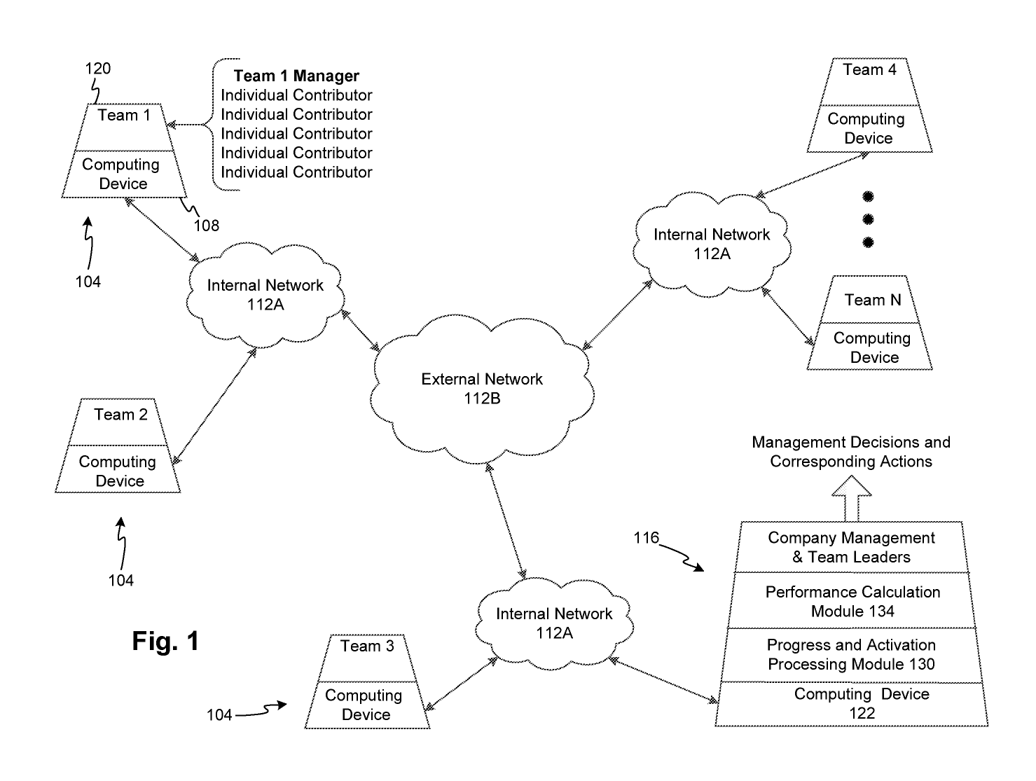

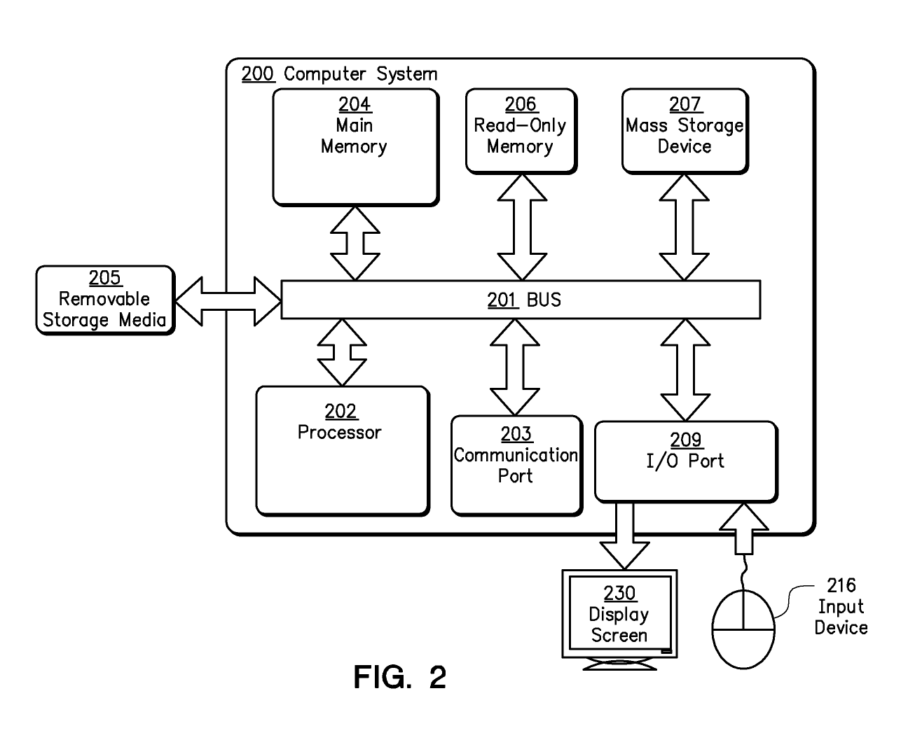

FIG. 1 illustrates an example environment of use of the method disclosed herein and an overview of the various elements which enable operation. Computing devices 108 are located at one or more locations 104. The locations may be different locations within a building or geographically different locations such as in different cities, states, or countries. The computing device 108 may comprise any type computer or network device capable of receiving user input and processing data and/or software code. FIG. 2 illustrates an exemplary computing device 108 capable of executing the method described herein.

The computing devices 108 are connected by internal networks 112A and an external network 112B. The internal networks 112A and external networks 112B may comprise any type network that is capable of exchanging data between computing devices. The computing devices 108 at each location 104 in combination with the networks 112 allow data to be provided to or collected by a management location 116 and a computing device 122 located at the management location.

At one or more of the locations, there are one or more teams 120 (shown as teams 1-N, where N is any whole number. The teams 120 are composed of one or more individuals that perform tasks to advance a project. In one example embodiment, the project is programming software code as part of a company or customer request. The projects may be referred to herein as user stories, which is an accepted term in Agile based project management. As shown in this example embodiment, the team 120 comprises a team manager and one or more individual contributors. In other embodiments, the team may be made up of any number or categories of people.

In general, the individuals that form the team perform collectively as a team and each individual has tasks to which they are assigned. Each aspect of the user story (project) performed by the team and the individual may be tracked. Information regarding the team's progress and activities, and an individual's progress and activities may be entered into a computing device 108 at each location 104 and optionally uploaded to the computing device 122 at the management location 116.

At the management location, or any of the other locations 104, are one or more software applications executing on a processor of a computing device 122. In this example embodiment there are two software applications executing on the computing device 122. In some embodiments, these two software applications may be combined into a single software application. One such software application is the progress and activities processing (PAP) module 130. The PAP module receives the individual and team progress and activity data from the various locations 104 and teams 120. The progress and activity data may be stored in a database or memory or processed upon receipt by the PAP module 130 to create the metric values.

In one configuration, the PAP module 130 comprises machine readable code stored on a tangible medium, such as a memory, which is executed by a processor of the computing device 122. The PAP module 130 processes the progress and activity data to generate team metrics and individual metrics that quantify, typically using numeric values, one or more aspects of the progress and activity data. The processing may accompany any number of different processing steps including but not limited to adding the progress and activity data from the different teams 120 to generate summed values. Likewise, the progress and activity data reported for a certain first time period may be summed with prior progress and activity data from a second time period to generate a total value over time. Division may occur to establish efficiency numbers. In one embodiment, these team metrics and individual metrics are based on the Agile software development methods. Agile software development methods are understood by those of ordinary skill in the art and hence not discussed in great detail herein. In other embodiments, other team metrics and individual metrics may exist or be developed other than those set forth by the agile software development protocols.

As part of the agile software development methods, or other team and individual metric tracking, the following metrics may be developed and processed by the PAP module 130. This list of variables is not exclusive and the method and apparatus disclosed for processing these metrics may rely on a subset of these metric or additional metrics. The term user story and project may be used in interchangeably.

Team Productivity Metric—The team productivity metric defines a throughput average. For example, the team productivity metric defines the number of user stories which are processed by the team. This value may be over a set period of time, such as the 12 month average number of user stories that the team has accepted by a customer per month. In this embodiment the user story is a request for a software feature from a customer. The customer can be an internal company request, a customer serviced by the company, or a customer proxy including a reseller or a business unit. The acceptance of a user story by a customer is an indicator that the user story (project request) is complete and accepted by the customer. The goal for productivity is to have this metric increasing or held steady at a high number.

IC Productivity Metric—The individual contributor (IC) productivity metric defines a throughput average by an individual. Thus, the IC productivity metric defines the number of user stories which are processed by an individual. This value may be over a set period of time, such as the 12 month average number of user stories that a particular individual has had accepted by a customer per month.

Throughput Average—The throughput average is related to or may be used to define the number of user stories (projects) that the team has accepted per time period, such as per month. In the discussions that follow the term throughput average may be used in the place of the productivity metric for both teams and individuals to aid in understanding.

Quality Metric—the quality metric is the net change in total defect count during a particular time period, such as the last 30 days. In other embodiments, other time frames or windows are utilized. The quality metric may be defined in terms of the change in the total number of defects. The change may be defined as the total defects, or the total number of defects minus the number of defects which have been fixed (open verses closed defects). A defect is defined as an error or mistake in a project, such as during the work on a user story. In computer programming a defect may be a program feature that is not functioning properly. The goal for the quality metric is to have it stabilized as zero defects during the time period in question.

Defect Trend—The defect trend is related to or may be used to define quality in that the defect trend is the net change in total defect counts. In the discussions that follow the term defect trend may be used in the place of the quality metric to aid in understanding.

Efficiency Metric—The efficiency metric is the 12 month average number of days that user stories (projects) take to move from a defined state to an accepted state. The defined state may be a state in which the project is groomed or ready for development. In other embodiments, the efficiency metric may be based on other than 12 month average. The efficiency metric is a measure of cycle time average for a project to move from a defined or in progress state to a completed or accepted state. In one embodiment, the efficiency is the time it takes for a project to move through its lifecycle. The goal for the efficiency metric is to stabilize it at a low value.

Cycle Time Average—The cycle time average is related to or may be used to define the number of days that user stories (projects) move from a defined state (such as groomed/ready for development) to an accepted state. This may be defined in days or other measure of time. To aid in understanding, in the discussions that follow the term cycle time average may be used in the place of the efficiency metric for both teams and individuals.

Predictability Metric—the predictability metric is an indicator of the 12 month standard deviation of the average number of days that user stories (projects) take to move from a defined state to an accepted state. The defined state may be a state in which the project is accepted or ready for development, such as for the individual to start programming. An accepted state, as set forth above, is when the user story is accepted by the customer or user. The predictability metric is a measure of the cycle time standard deviation and in this embodiment is measured in days.

Cycle Time Standard Deviation—The cycle time standard deviation is related to or may be used to define the 12 month (or other time period) standard deviation of the average number of days that user stories (projects) move from a defined state (such as groomed/ready for development) to an accepted state. To aid in understanding, in the discussions that follow the term cycle time standard deviation may be used in the place of the predictability metric for both teams and individuals.

Weighting factor—It is contemplated that a weighting variable may be established that weights one or more of the metric variables discussed above to establish it as having a greater or lesser impact in the processing describe below. For example, if a user of the software wanted to emphasize a particular metric, such as defects, then the defect could be weighted with a weighting factor greater than one. The weighting factors may comprise any value that is less than one or greater than one.

Referring again to FIG. 1, the data that represents these metrics or variable, or data that is used to calculate these variables as listed above is entered by the individuals in the teams or other employees of the company at the computing devices 104 and sent to the computing device 122 over the network 112. The PAP module 130 collects and stores this data. The PAP module 130 may also maintain running totals of the values or perform other calculations to generate these metrics.

The individual and team metrics described above are provided to a performance calculation module 134. In one embodiment the performance calculation module 134 is configured as part of the PAP module 130. The performance calculation module 134 processes the individual and team metrics to develop performance indicators. These performance indicators are provided to company management, team leaders, and/or individuals on the team (or other company personnel). The performance indicators provide information regarding the performance of the team or individual that may be considered and used as described below. The performance indicators may comprise numeric values, which may be compared to one or more threshold values. The threshold value may be set by the company or other factors and based on the comparison to the threshold values, the individual or team performance may be determined. For example, if the team performance indicator value is larger in magnitude than the team performance threshold value then that team is performing well.

In one embodiment, non-numeric categories may be provided to help upper management better understand the rankings. These categories may be great, good, average, and needs improvement or grade ratings such as A, B, C, and D. It is also contemplated that the performance indicators for each team or individual may be compared the performance indicators for other teams or individuals. As a result, the teams and individuals may be ranked against each other.

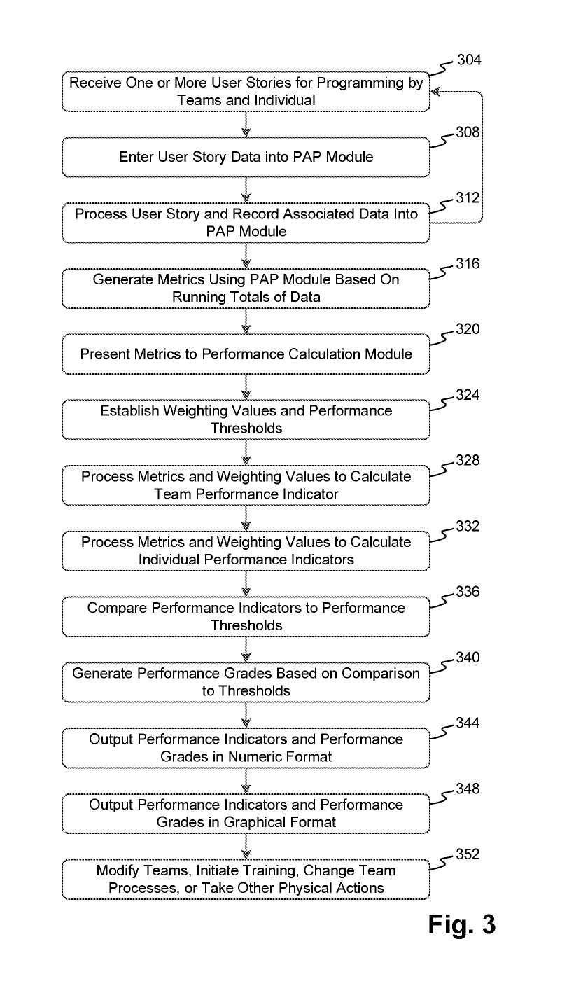

Based on the performance indicators calculated by the performance calculation module 134, one or more management decisions and corresponding actions may be taken by the company. The performance calculations are discussed below in connection with FIG. 3. Because the management has understandable and quantifiable performance indicators for the teams and the individuals within the team, management decisions may be made based on such data. It is contemplated that the management may request additional training for certain teams or individuals with low performance indicators. Management may also be included to move individuals from one team to another team to modify or adjust team performance. This would involve movement of the individual worker to a different team, different location in the company or a different city.

Management may also elect to not maintain employment of other individuals who perform below minimum performance thresholds. In other situations management may change the manner in which teams operate or the internal processes are executed when certain teams perform better when operating under changed internal processes. It is also contemplated that different team leaders may be appointed to a team or other management change may occur as result of the performance indicators. Individuals may also self-analyze or work with performance coaches or mentors to improve their personal performance. In most instances individual team members want to perform well and maintain employment/advancement options and therefore by seeing their individual performance indicators they may be able to improve.

FIG. 2 is a schematic diagram of a computer system 200 upon which embodiments of the present invention may be implemented and carried out. For example, one or more computing devices 108, 122 as shown in FIG. 1 may be configured based on the embodiment of FIG. 2 to perform the method described herein. The computer system 200 generally exemplifies any number of computing devices, including general purpose computers (e.g., desktop, laptop or server computers) or specific purpose computers (e.g., embedded systems).

According to the present example, the computer system 200 includes a bus 201 (i.e., interconnect), at least one processor 202, at least one communications port 203, a main memory 204, a removable storage media 205, a read-only memory 206, and a mass storage 207. Processor(s) 202 can be any known processor, such as, but not limited to an Intel® Itanium® or Itanium 2® processor(s), AMD® Opteron® or Athlon MP® processor(s), or Motorola® lines of processors.

The communications ports 203 can be any of an RS-232 port for use with a modem based dial-up connection, a 10/I00 Ethernet port, a Gigabit port using copper or fiber, or a USB port. The communication port(s) 203 may be chosen depending on a network such as a Local Area Network (LAN), a Wide Area Network (WAN), or any network to which the computer system 200 connects. The computer system 200 may be in communication with peripheral devices (e.g., display screen 230, input device 216) via an Input/Output (I/O) port 209.

The main memory 204 can be Random Access Memory (RAM), or any other dynamic storage device(s) commonly known in the art including flash memory, optical memory or remotely located memory often referred to as cloud storage. The read-only memory 206 can be any static storage device(s) such as Programmable Read-Only Memory (PROM) chips for storing static information such as instructions for the processor 202. The mass storage 207 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

The bus 201 communicatively couples the processor(s) 202 with the other memory, storage and communications blocks. The bus 201 can be a PCI/PCI-X, SCSI, or Universal Serial Bus (USB) based system bus (or other) depending on the storage devices used. The removable storage media 205 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), etc.

Embodiments of the software code or application as described herein may be provided as a computer program product, which may include a machine-readable code stored in a non-transient state on a medium (memory) having stored thereon instructions, which may be used to program a computer (or other electronic devices) to perform a process. The machine readable code may be executable by a processor. The machine-readable medium (memory) may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

As shown, the main memory 204 is encoded with the software that supports functionality as discussed herein. For example, the main memory 204 or the mass storage device 207 may store the software code configured to perform the processing described below.

During operation of one embodiment, processor(s) 202 accesses main memory 204 via the use of bus 201 in order to launch, run, execute, interpret or otherwise perform the logic instructions of the software code stored in memory.

It should be noted that in addition to the software code stored in memory, data may also be stored in the memory 204, 207. The data may comprise any type of data as described herein to carry out the functionality described below. The software code may read and process the data as described below to perform the processing in accordance with the claims. The software code may be stored on a computer readable medium (e.g., a repository) such as a hard disk or in an optical medium. According to other embodiments, the software code 250 can also be stored in a memory type system such as in firmware, read only memory (ROM), or, as in this example, an executable code within the main memory 204 (e.g., within Random Access Memory or RAM). Thus, those skilled in the art will understand that the computer system 200 can include other processes and/or software and hardware components, such as an operating system that controls allocation and use of hardware resources.

FIG. 3 illustrates an operational flow diagram of an example method of operation. This is but one possible method of operation and it is contemplated that one of ordinary skill in the art may arrive at alternative methods of operation which do not depart from the claims that follow. In this method of operation, the order of the various steps may be performed in different order or the order shown in FIG. 3. In addition, an embodiment may be performed using only a subset of the listed steps, or additional steps may also be performed to provide additional functionality.

In this exemplary method, at a step 304 the company or other entity receives one or more user stories to be completed by the teams and/or individuals. The user story is a term of art based on the Agile methodology and may be considered as a project. In this embodiment, completing these projects comprises performing software code programming and testing but in other embodiments other activities may be performed instead of or in addition to software programming.

At a step 308 the user story is entered into the PAP module 308. Entering the user story may comprise entering the project itself, or one or more additional project parameters about individuals/teams working on the project. At a step 312, the systems, such as the computing device 122 in FIG. 1, processes the user story and records associated data into the PAP module. After step 312 the operation returns to step 304 for further processing and also advances to a step 316. By returning to step 304, the system is always available to accept additional user stories and tracking progress of the projects.

Then at step 316 the method of operation generates metrics using the PAP module based on running totals of data from the work on the user story (project). The metrics are indicators or data regarding one or more aspects of the project, and the team and individual activity on the user project. The metrics may be for a single user story or represent a combination of multiple different user stories which are in progress.

At a step 320, the operation presents the metrics from the PAP module to the performance calculate module 320. This may comprise entering the data manually, performed by a user, or electronically within the same software package. Likewise, at a step 324 a weighting value may be established for use in subsequent calculations. The weighting value is an optional value that may be selected to weight any of the variables in the calculations to a greater or lesser degree. In addition, at step 324 the operation may be presented with or determine one or more performance thresholds. The performance threshold comprises a value or magnitude to which the team performance indicator and individual performance indicators are compared. Evaluations or conclusions may occur, as described below, based on this comparison. Performance indicators below the threshold may signal a need for action as described herein.

Next, at a step 328 the operation processes the metrics and weighting values to calculate a team performance indicator. In one embodiment the team performance indicator is a numeric value that results from a calculation of the metric values, weighting value, and one or more other optional values or time frames. In other embodiments the result of the team performance calculation is other than a numeric value, such as a graphical or textual output. Each team may receive a performance indicator.

In one example embodiment the team performance calculation comprises a calculation based on the following equation.

$$Team Performance = \frac{\begin{matrix}Throughput Average - \\ ( Weighting Value * Defect Trend )\end{matrix}}{( Cycle Time Average ) + Predictability}$$

In one embodiment the team productivity index is defined as: ((Productivity Trend Weight*Productivity)−(Defect Trend Weight*Quality))/((Efficiency Trend Weight*Efficiency)+(Predictability Trend Weight*Predictability))

These are example possible calculations for team performance. In other embodiments the variable may be changed or the mathematical operations may be adjusted. In addition, is also contemplated that a weighting factor may be added to any of the other variables in the numerator or denominator to adjust the weighting for each variable in the equation. For example, any one or more of the following variables may be weighted using a weighting value: throughput average, cycle time average, cycle time standard deviation, individual throughput average, and/or team throughput average. The value of each weighting value may be the same or different.

The operation may also process the metrics and weighting values to calculate an individual performance indicator. This occurs at a step 332. In one example embodiment, the individual performance calculation comprises a calculation based on the following equation.

$$Individ . Perfor . = \frac{Throughput Average - ( Weighting Value * Defect Trend )}{\begin{matrix}( ( Cycle Time Aver . + Cycle Time Stand . Devint . ) * \\ \frac{Individ . Throughput Aver .}{Team Throughput Average}\end{matrix}}$$

This is but one possible calculation for individual performance. In other embodiments, the variables may be changed or the mathematical operations may be adjusted.

It is also contemplated that a weighting factor may be added to any of the other variables in the numerator or denominator to adjust the weighting for each variable in the equation. For example, any one or more of the following variables may be weighted using a weighting value: throughput average, cycle time average, cycle time standard deviation, individual throughput average, and/or team throughput average.

At a step 336 the calculated performance indicators, namely the team performance indicator and the individual performance indicator are compared to the one or more thresholds. For example, the team performance indicator may be compared to a team performance threshold to determine if a team's performance is above or below the predetermined threshold level. Likewise, the individual performance indicator may be compared to an individual performance threshold to determine if an individual's performance is above or below the predetermined threshold level. An individual performance indicator may be established for each individual, or for groups of individuals or for the entire group of individuals at the company. Likewise, teams may be compared to thresholds tailored for that team, or to a standardized team threshold level.

At a step 340, the operation may optionally generate performance grades based on the comparison to the thresholds or based on whether the performance indicators are increasing or decreasing over time. The grades may be numeric or textual, such as A, B, C in nature. At a step 344, the operation outputs the performance indicators and the performance grades to the user of the performance module in a numeric format. While numbers are helpful, it is also contemplated that it may also be helpful to a user, such as manager or an individual worker, to have the performance indicator represented in a graphical format. This may occur at a step 348.

At a step 352, one or more physical steps or actions may be taken based on the performance indicators. For example a manager may review the performance indicators and then modify the structure of the teams to balance stringing individuals with individuals with lower performance scores. This may involve physically changing, swapping, or moving the team members. Additional training may be required for individuals with low scores or a different type of training may occur. Hence, teams or individuals may be sent to or be provided additional training. The team processes may also be changed such that the procedures or activities of the team may be changed to improve work flow or metrics. The programming language may be changed or any other physical change may occur as a result of the performance calculations.

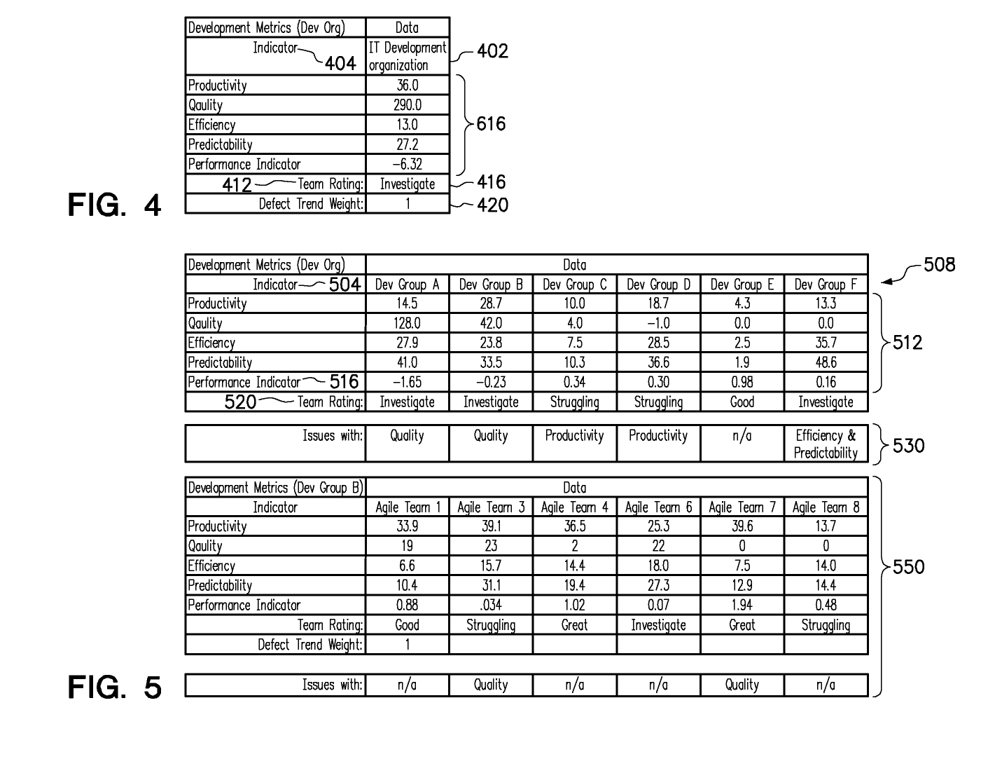

To aid in understanding and provide additional details regarding the results of the calculations discussed above, FIGS. 4-9 illustrate output of the calculations. As can be appreciated this provides a useful tool to management and the team members for evaluating and improving performance. These figures provide exemplary data output and layout and the claims that follow are not limited to this configuration and dataset.

FIG. 4 illustrates exemplary combined or summarized data results in the form of development metrics for an exemplary group, in this embodiment IT development organization 402. The indicators 404 include productivity, quality, efficiency, predictability and an overall performance indicator as shown. Numeric values 408 associated with each indicator 404. A team rating 412 is also shown as a non-numeric value 416. The team rating 412 may defined the performance in terms of high, average, or low, or provide instructions to management, such as investigate. A defect trend weight 420 is also shown.

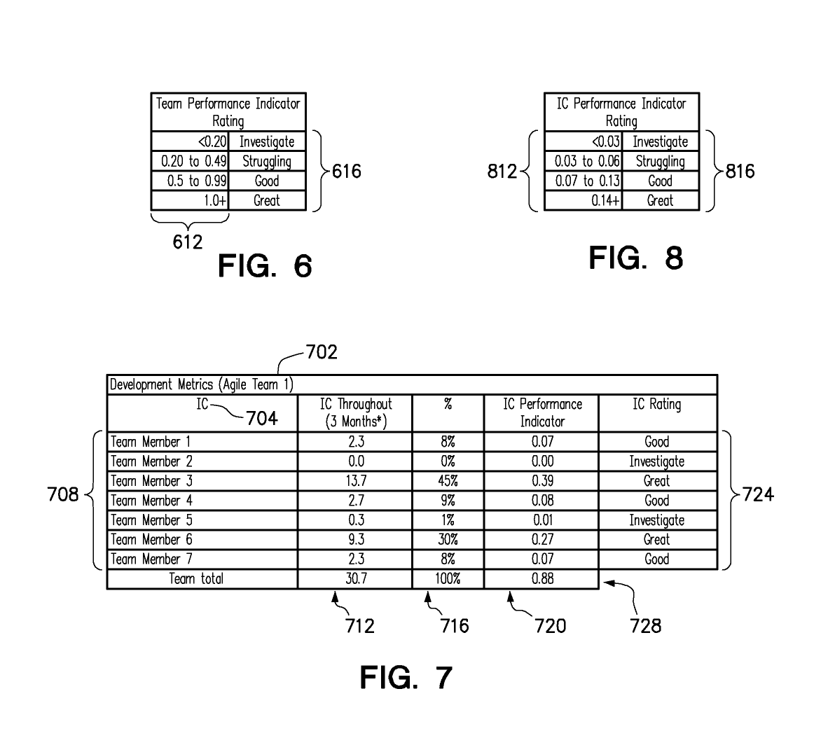

FIG. 5 illustrates an expanded set of development metrics for development group. In this expanded version, the indicators 504 are shown for each group including Development Group A through Development Group F. For each group a numeric score 512 is provided for the indicators of productivity, quality, efficiency, predictability and the overall performance indicators 516. The performance indicators 516 provides a summary or overall score for the performance based and the calculations described above. The key described below in FIG. 6 translates the numeric scores for the performance indicators 526 to the text based performance ratings 520 shown below the numeric performance indicator values 516. Using the define team ratings, the management can quickly assess the team performance and rating.

Below the team ratings 520 are identifiers 530 that is established and shown by the system. In this example embodiment, the identifiers 530 comprise one of the indicators 504. The identifier 530 lists which of the indicators 504 is causing the development group 508, identified in that column, to receive a low rating. For example, for development group A, the quality indicator with a score of 14.5 is too low, which in turn causes the team rating 520 to receive an investigate rating. The information displayed in section 550 is generally similar to that shown directly above in sections 508, 512, 530 but is directed to Agile Teams 1-7. As a result, this section 550 is not discussed in detail.

FIG. 6 illustrates an exemplary key for the development metrics for team performance indicators ratings as shown in FIG. 5. As shown in FIG. 6, the numeric ranges 612 are defined and associated with the non-numeric ratings 616 of investigate, struggling, good and great. In other embodiments other ranges and associated non-numeric ratings may be established.

FIG. 7 illustrates a chart of development metrics for individual team members of Agile Team 1 702. Agile Team 1 is shown in FIG. 5. This chart shown in FIG. 7 provides detail regarding each team member. As shown, each IC (individual contributor) 1-7 which are defined as team members in section 708. For each team member, a throughput value 712 is provided in the chart. In this example chart, the throughput is listed for the prior 3 months. Adjacent the throughput column 712 is the percentage value 716 which lists the throughput for teach team member as a percentage of the entire throughput. A performance indicator column 720 lists the value resulting from the individual contributor performance calculations describe above. Totals for the team are listed in the chart along a bottom row 728 while the individual contributor non-numeric ratings are shown in the chart at column 724.

FIG. 8 illustrates an exemplary key for the individual contributor performance indicators ratings as shown in FIG. 7. As shown in FIG. 8, the numeric ranges 812 are defined and associated with the non-numeric ratings 816 of investigate, struggling, good and great. As compared to FIG. 6, although the non-numeric indicators 816 are the same, the numeric ranges 812 are different. In other embodiments, other ranges and associated non-numeric ratings may be established.

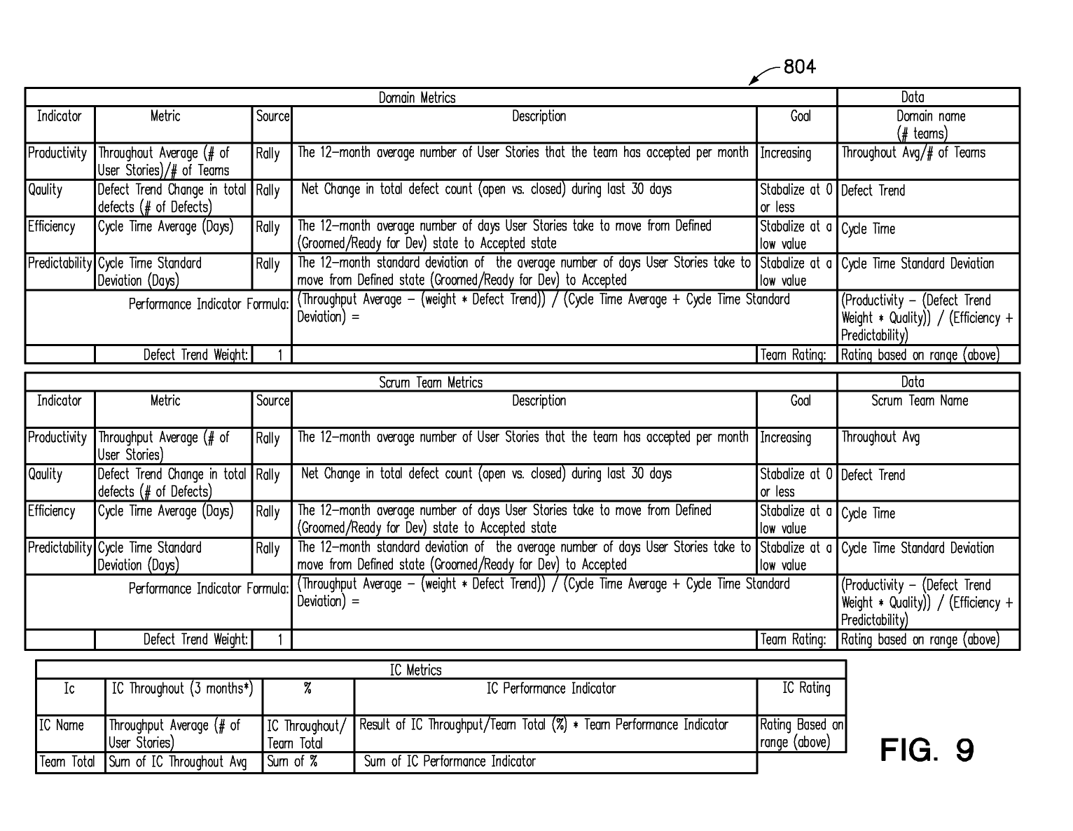

FIG. 9 illustrates an exemplary chart of definitions with team and team member goals for domain metrics, scrum team metrics, and individual contributor metrics. The content of this chart is discussed above and as such each entry in each chart is not discussed again. This table may be used by management to better understand and define each metric and value shown in FIGS. 4-8. Also in the chart is a goal entry 804 which lists the preferred action for a particular indicator. For example, this may include increasing, stabilizing a particular indicator.

As can be appreciated from these figures, the method and apparatus discussed herein provides a manager the ability to roll up measurement/scoring from individual to team, team to domain, domain to business unit, and business unit to enterprise. Thus, from one chart to the next or one page to the next, manager may review and examine the manager charge from a high level to a detailed level, which may be referred to as drilling down. The system is also scalable to accommodate any size of organization.

In summary, there is a need for software product development managers to have a scalable, balanced, performance indicator that can compare team to team or individual to individual performance, encourage positive behavior, and can also be applied at the individual contributor level. The Agile product development methods typically recommend that managers collaborate with development teams to get a sense of the level of a team's performance. As discussed above, this recommendation is understandable but it is not feasible for upper-management to collaborate with numerous development teams on a regular basis or to be able to accurately monitor each team and individual. Having a team performance indicator based on Agile based development metrics allows upper-management to quickly identify teams that may be struggling and in need of management intervention. Another benefit for upper-management from this system is to be able to baseline and track trends in performance at all levels of the organization with the goal to achieve incremental and continuous improvement.

One of the benefits of the method and system disclosed herein is that it is “balanced” such that all individuals are members of teams. The balancing of the formulas takes this into account by showing the individuals contribution to the team and how they must account to the team to not disadvantage the other team members as part of the metric determinations. Thus, the balanced concept allows top performers to be recognized for that performance, but not at the detriment of the overall team performance without that behavior being abundantly clear. For example, if one team member makes themselves look like a top performer by taking advantage of other team members, then while that top performer individual ratings will be high, the other team members scores will be low, which will be clearly apparent from the charts.

Currently there is no performance indicator in the Agile product development methodology or any other development methodology that balances key objectives including throughput, cycle-time, predictability, quality, and synergy (teamwork). Also, there is not an individual level performance indicator that can be used in Agile software product development. Certain popular Agile metrics like “Velocity” are not effective as a performance metric because it is not possible to compare across teams and there are typically unintended consequences associated with using this metric as a management metric. Agile Application Lifecycle Management (ALM) software tool vendors such as Rally Software located in Boulder, Colo. and Version One located in Jersey City, N.J., offer several metrics but currently do not offer a single, scalable, balanced, indicator as set forth above that compares team to team performance, encourages positive behavior between teams, and within the team, to increase the performance, and can also be applied at the individual contributor level.

The solution set forth above can utilize available or easily obtainable data from many Agile Application Lifecycle Management (ALM) software tools and will satisfy the needs of software product development managers by providing the ability to scale to the organizational, domain, team, and individual level, the ability to compare domain to domain, team to team, and individual to individual, the ability to balance key objectives including throughput, cycle-time, predictability, quality, and synergy (teamwork), and the ability to encourage positive behavior.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A method of determining performance indicators and improving performance based on the performance indicators comprising:
receiving a user story for completion, the user story defining a computer programming project for a customer to be performed by a team, the team formed from individuals;
performing computer programming on a user story to write software code;
tracking one or more aspects of the computer programming based on the user story;
generating two or more metrics, based on the tracking, regarding the team and individual actions when writing software code for the user story;
calculating one or more performance indicators using two or more metrics;
displaying the one or more performance indicators; and
responsive to the one or more performance indicators, taking one or more actions, the actions comprising: providing training to a team or an individual on the team, moving an individual from the team to a different team, changing one or more physical processes by which the team or an individual on a team works on the user story, and terminating employment of an individual on a team.

2. The method of claim 1 wherein calculating one or more performance indicators comprises calculating a team performance indicator using the following equation:
$$Team Performance = \frac{\begin{matrix}Throughput Average - \\ ( Weighting Value * Defect Trend )\end{matrix}}{( Cycle Time Average ) + Predictability}$$

3. The method of claim 1 wherein calculating one or more performance indicators comprises calculating an individual performance indicator using the following equation:
$$Individ . Perfor . = \frac{\begin{matrix}Throughput Average - \\ ( Weighting Value * Defect Trend )\end{matrix}}{\begin{matrix}( ( Cycle Time Aver . + Cycle Time Stand . Devint . ) * \\ \frac{Individ . Throughput Aver .}{Team Throughput Average}\end{matrix}}$$

4. The method of claim 1 wherein the metrics comprise at least one of the following metrics: Team Productivity Metric, IC Productivity Metric, Throughput Average, Quality Metric, Defect Trend, Efficiency Metric, Cycle Time Average, Predictability Metric, and Cycle Time Standard Deviation.

5. The method of claim 1 wherein the method steps of generating two or more metrics and calculating one or more performance indicators are performed by machine readable code that is stored in a memory and executed by a processor of a computing device.

6. The method of claim 1 further comprising establishing a weighting value and applying the weighting value to one of the two or more metrics when calculating the one or more performance indicators.

7. The method of claim 1 further comprising establishing a performance indictor threshold and comparing the performance indictor threshold to one or more performance indicators to generate a non-numeric indicator of the calculated performance indicator.

8. A method for calculating performance indicators comprising:
receiving or generating two or more metrics regarding team performance or individual performance on a project;
calculating one or more performance indicators using the two or more metrics, the performance indicators indicating the performance of a team or an individual;
displaying the one or more performance indicators on a screen.

9. The method of claim 8, further comprising taking one or more actions responsive to the one or more performance indicators, the actions comprising: providing training to a team or an individual on the team, moving an individual from the team to a different team, changing one or more physical processes by which the team or an individual on a team performs work on the user story; terminating employment of an individual on a team.

10. The method of claim 8 wherein calculating one or more performance indicators comprises calculating a team performance indicator using the following equation:
$$Team Performance = \frac{\begin{matrix}Throughput Average - \\ ( Weighting Value * Defect Trend )\end{matrix}}{( Cycle Time Average ) + Predictability}$$

11. The method of claim 8 wherein calculating one or more performance indicators comprises calculating an individual performance indicator using the following equation:
$$Individ . Perfor . = \frac{\begin{matrix}Throughput Average - \\ ( Weighting Value * Defect Trend )\end{matrix}}{\begin{matrix}( ( Cycle Time Aver . + Cycle Time Stand . Devint . ) * \\ \frac{Individ . Throughput Aver .}{Team Throughput Average}\end{matrix}}$$

12. The method of claim 8 wherein the two or more metrics comprise at least one of the following metrics: Team Productivity Metric, IC Productivity Metric, Throughput Average, Quality Metric, Defect Trend, Efficiency Metric, Cycle Time Average, Predictability Metric, and Cycle Time Standard Deviation.

13. The method of claim 8 further comprising establishing a weighting value and applying the weighting value to one of the two or more metrics when calculating the one or more performance indicators.

14. The method of claim 8 further comprising establishing a performance indictor threshold and comparing the performance indictor threshold to one or more performance indicators to generate a non-numeric indicator of the calculated performance indicator.

15. A system for calculating a performance indicator comprising:
a processor configured to execute machine readable code;
a memory storing non-transitory machine readable code, the machine readable code configured to:
receive input regarding team activity, individual activity, or both on a project;
generate metrics defining the team activity, individual activity, or both on the project;
calculate a team performance indicator, an individual performance indicator, or both based on at least two of the metrics;
output the team performance indicator, individual performance indicator, or both on a screen.

16. The system of claim 15 wherein the team performance indicator is calculated using the following equation:
$$Team Performance = \frac{\begin{matrix}Throughput Average - \\ ( Weighting Value * Defect Trend )\end{matrix}}{( Cycle Time Average ) + Predictability}$$

17. The system of claim 15 wherein the individual performance indicator is calculated using the following equation:
$$Individ . Perfor . = \frac{\begin{matrix}Throughput Average - \\ ( Weighting Value * Defect Trend )\end{matrix}}{\begin{matrix}( ( Cycle Time Aver . + Cycle Time Stand . Devint . ) * \\ \frac{Individ . Throughput Aver .}{Team Throughput Average}\end{matrix}}$$

18. The system of claim 15 wherein the machine readable code is further configured to establish a weighting value and applying the weighting value to at least one of the metrics when calculating the team performance indicator, individual performance indicator, or both.

19. The system of claim 15 wherein the machine readable code is further configured to receive a performance indictor threshold and compare the performance indictor threshold to team performance indicator or the individual performance indicator.
